(19) United States
(12) Patent Application Publication
(10) Pub. No.: US 2008/0014908 A1
(43) Pub. Date: Jan. 17, 2008

(54) SYSTEM AND METHOD FOR COORDINATING CUSTOMIZED MOBILITY SERVICES THROUGH A NETWORK

(76) Inventor: Abraham Vasant, Livermore, CA (US)

Correspondence Address: Kunzler & McKenzie, 8 EAST BROADWAY, SUITE 600, SALT LAKE CITY, UT, 84111, US

(21) Appl. No.: 11/779,250

(22) Filed: Jul. 17, 2007

Related U.S. Application Data
(60) Provisional application No. 60/807,571, filed on Jul. 17, 2006.

(51) Int. Cl. H04Q 7/38

(52) U.S. Cl. 455/414.1

(57) ABSTRACT

A system and method are disclosed for coordinating customized mobility services through a network. The system includes a network, an access device configured to connect to the network, a server configured to communicate with the access device through the network, an identification module configured to identify a user's customer account and to associate at least one mobility service with the user's customer account, and a virtual mobile attendant configured to coordinate customized mobility services through the network. The method includes receiving personal vehicles supply information from at least one transit management system, receiving demand information from a virtual mobility attendant, determining target information from the supply information and the demand information for the personal vehicles in a vicinity most closely matching the end user demand information, and transmitting the target information to the virtual mobility attendant.

### CROSS-REFERENCES TO RELATED APPLICATIONS

This application claims priority to U.S. Provisional Patent Application No. 60/807,571 entitled “APPARATUS, SYSTEM, AND METHOD FOR COORDINATING CUSTOMIZED MOBILITY SERVICES THROUGH A NETWORK” and filed on Jul. 17, 2006 for Abraham Vasant, which is incorporated herein by reference.

### BACKGROUND OF THE INVENTION

1. Field of the Invention

The invention relates to apparatus, systems and methods for arranging transportation and more specifically relates to apparatus, systems and methods for coordinating customized mobility services through a network.

2. Description of the Related Art

To get from one place to another and to arrive on time is a daily challenge representative of the modern transportation age. As large cities continue to grow and transportation systems become more complex, the challenge to maintain a preferred schedule becomes greater. Technological advances in communications and computer systems have literally brought the world to one's finger tips. Yet, life “on the run” continues to be a series of stops and inquiries, as one tries to determine the quickest way to arrive at a desired destination, without getting held up in congested traffic. Transportation systems, such as the buses, trains, taxi and shuttle services, and the like, facilitate mobility, but typically do not provide coordinated services that enable the user to determine the best route or mode of transportation to reach a destination. In addition, a separate ticket or fee may be required to transfer from one form of transportation to another.

What is needed is an apparatus, system, and method that provides coordinated information and services while in transit to allow the user to determine a preferred transportation mode and route and to arrive at a destination as efficiently as possible. Beneficially, such an apparatus, system, and method would enable the user to make informed decisions and to travel quickly and efficiently from one destination to another. In addition, the apparatus, system, and method would automate routine practices, such as purchasing a ticket and checking time schedules, in order to minimize the amount of time required to transfer from one vehicle or transportation device to another.

### SUMMARY OF THE INVENTION

The present invention has been developed in response to the present state of the art, and in particular, in response to the problems and needs in the art that have not yet been fully solved by currently available apparatus, systems, and methods for arranging transportation. Accordingly, the present invention has been developed to provide an apparatus, system, and method for coordinating customized mobility services through a network that overcomes many or all of the above-discussed shortcomings in the art.

The apparatus, in one embodiment, is configured to exist in a network that is accessible from multiple locations and access devices. The apparatus may provide a virtual mobility attendant (VMA) having a tracking module, synchronization module, and a coordination module in certain embodiments. In one embodiment, the tracking module tracks the location of the user and/or other entities, such as a transportation device. In certain embodiments, the user and/or the VMA may access a GPS (Global Positioning System) enabled device to determine the location of the user relative to surrounding objects and/or relative to moving objects such as a vehicle. The VMA may further determine an estimated time of arrival and may communicate the time estimation and/or user location to relevant parties.

In one embodiment, the VMA may be further configured to synchronize user input and at least one mobility service. For example, the VMA may synchronize a personal calendar or “to do” list with the location of the user. As a result, the VMA may provide reminders, suggestions, information or the like to help the individual fulfill commitments. For example, if the user has a scheduled appointment in one part of town, the VMA may prompt the user to leave home at a certain time to assure plenty of time for travel. In a further embodiment, the VMA may receive traffic reports or the like and prompt the user to leave earlier than appointed to avoid delays, or to take an alternative route to arrive on schedule.

In a further embodiment, the VMA may be configured to coordinate user data and collective data to provide at least one mobility service customized to the user. In one embodiment, the VMA may determine user data, such as current location and desired destination. The VMA may subsequently access pertinent information available on a network, such as the location of a shuttle service or the like. In certain embodiments, the VMA exchanges information between the user and the shuttle service to enable the shuttle service to coordinate with the user. For example, the shuttle may pick up the user at an unscheduled stop or location.

A system of the present invention is also presented to enable the VMA to provide mobility services to the user from multiple access devices. The system may be embodied in a network. In one embodiment, the network is wireless such as WiFi (Wireless Fidelity). The system, in one embodiment, includes a network, an access device configured to connect to the network, a server, and a VMA.

The user may access the VMA through the network with an access device. In certain embodiments, the user establishes a customer account that provides access to a plurality of mobility services. In one embodiment, the customer account may be linked with a financial account such as a bank account, credit account, or the like and may be used to transfer money to pay expenses, travel fees, or the like.

The system may further include an identification module to identify the user and to associate at least one mobility service with the user's customer account. In one embodiment, the identification module enables the system to automatically debit a financial account for services provided, such as a train ticket, taxi fare, or the like. Automatic debits may facilitate minimizing the amount of time associated with financial transactions and may further minimize travel time.

A method of the present invention is also presented for coordinating customized mobility services through a network. The method in the disclosed embodiments substantially includes the steps necessary to carry out the functions presented above with respect to the operation of the described apparatus and system. In one embodiment, the method includes tracking the location of the user and/or the location of a transportation device, synchronizing user input and at least one mobility service, and coordinating user data and collective data to provide at least one mobility service customized to the user. The method also may include identifying the user and associating at least one mobility service with a user's customer account.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a mobility coordination system in accordance with the present invention;

FIG. 2 is a schematic block diagram illustrating one embodiment of a virtual mobility assistant in accordance with the present invention;

FIG. 3 is a schematic flow chart diagram illustrating one embodiment of a mobility coordination method in accordance with the present invention;

FIG. 4 is a schematic flow chart diagram illustrating one embodiment of a coordinated mobility service in accordance with the present invention;

FIG. 5 is a schematic block diagram illustrating one embodiment of an overall infrastructure for a personal vehicle management system in accordance with the present invention;

FIG. 6 is a diagram illustrating cell zones and geographic areas in accordance with the present invention;

FIG. 7 is a schematic block diagram illustrating another embodiment of the system in accordance with the present invention; and

FIG. 8 is a schematic block diagram illustrating one embodiment of a method for utilizing the vehicle management system in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical modules of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

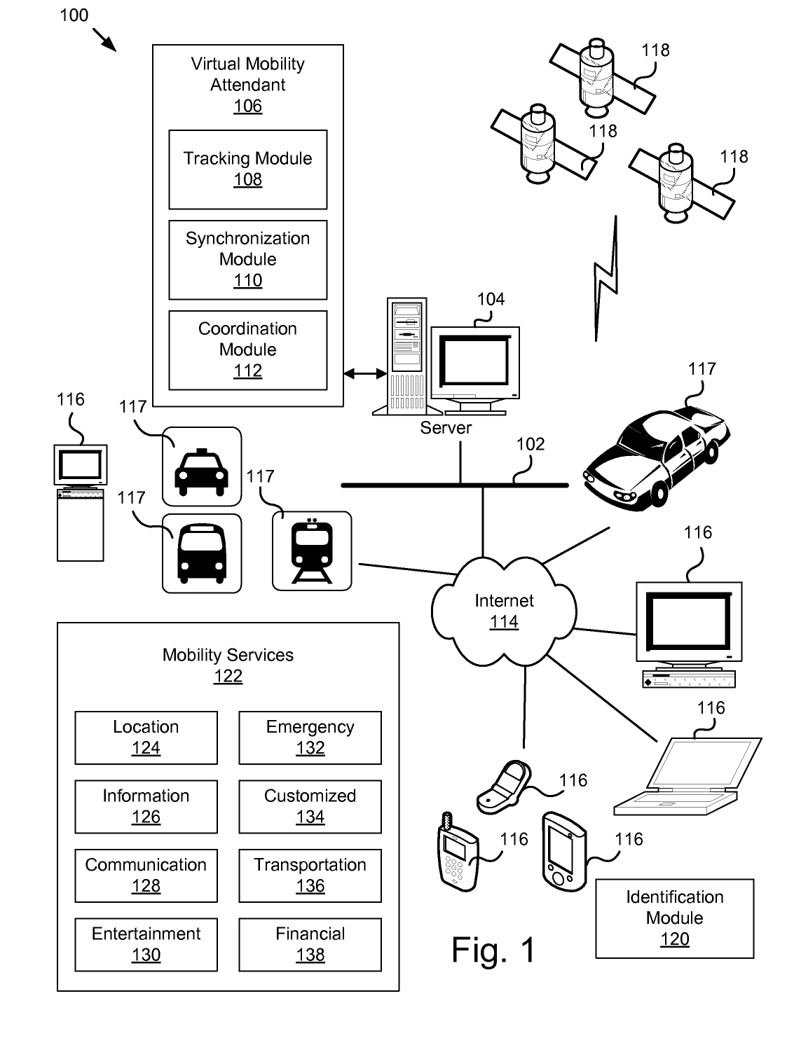

FIG. 1 illustrates one embodiment of a mobility coordination system 100 for coordinating customized mobility services through a network 102. In the depicted embodiment, a server 104 is connected to the network 102 and comprises a virtual mobility attendant (VMA) 106 that is accessible through the network 102. The VMA 106 may comprise a tracking module 108, a synchronization module 110, and a coordination module 112. The network 102 may be a wired and/or a wireless network. In a preferred embodiment, the network 102 is accessible through the internet 114 and is available through wireless access.

The server 104, in one embodiment is configured to information regarding the user and the transportation options available to the user. For example, the server 104 is configured to receive location updates from the user over the internet and determine an optimal route for the user in order to arrive at the user's intended destination. The server 104 is configured to select from available transportation options, such as, but not limited to, busses, taxis, carpools, trains, planes, etc. The server 104 is further configured to determine the optimal route for the user based upon available traffic information. For example, if the interstate highway is congested due to an accident, the server 104 may indicate to the device 116 that a better route is to take the train and bypass the interstate highway.

One or more access devices 116 including wireless-enabled transport units 117 may access the VMA 106 through the internet 114 or the like. An access device 116 may be any device that is enabled to connect to the network 102 and access the VMA 106. Examples of the access device 116 may include, but are not limited to, a kiosk terminal, a portable computing device, a dashboard computer, a desktop computer, a cellular phone, and the like. In select embodiments, the access device 116 and/or transport unit 117 is GPS enabled to facilitate the tracking process and may receive location information from a system of satellites 118 as is known in the art. Alternatively, radio triangulation may be utilized to enable location-based tracking. For example, location information may be determined by triangulating the position of the device 116 in relation to a plurality of cell phone towers. In certain embodiments, the system 100 tracks in real time the position of the user, transport units 117, access devices 116, and the like.

Alternatively or in addition, the access device 116 may include an identification module 120, which may be used to identify the user and may further be used to locate and/or track the user in certain embodiments. The identification module 120 may include, for example, credit cards, an RFID (Radio Frequency Identification) device, bar-coded key tags, magnetic strips, Bluetooth technology, card readers, or the like to track the user. The identification module 120 may be located in the transportation unit 117, the access device 116, and/or another strategically positioned device and may be associated with the user. In certain embodiments, the identification module 120 facilitates verifying the user. In an alternative embodiment, the user logs in to the customer account and reports a location.

In one embodiment, the identification module 120 is integrated into an unmanned kiosk terminal, such as those commonly located near bus stands, waiting areas, transit exchange points, etc. Consequently, a user may be identified by swiping a card, communicating ID information through Bluetooth or RFID technology, or the like. In certain embodiments, the kiosk may provide user access to the VMA 106 and related mobility services 122. The kiosk may facilitate enabling the user to locate an available transport unit 117 in certain embodiments.

In one embodiment, the access device 116 comprises a dashboard computer installed in a personal vehicle. One example of a personal vehicle is disclosed in U.S. provisional patent application No. 60/749,346 entitled “APPARATUS, SYSTEM, AND METHOD FOR EFFICIENT AND MANEUVERABLE VEHICLE” filed Dec. 9, 2005 for Abraham Vasant, which is incorporated herein by reference.

In one embodiment, the mobility coordination system 100 provides access to a plurality of mobility services 122 that facilitate traveling from one destination to another. Examples of mobility services 122 may include, but are not limited to: location services 124, information services 126, communication services 128, entertainment services 130, emergency services 132, customized services 134, transportation services 136, and financial services 138. In one embodiment, the user subscribes to one or more mobility services 122 and pays a monthly fee. As more mobility services 122 are added to the subscription, the monthly fee may increase. In certain embodiments, one or more mobility services 122 are outsourced to specialized and/or existing companies to provide a particular service.

In one embodiment, the location services 124 may include providing a user location, providing the location of other entities including landmarks, and providing visibility to others. In a further embodiment, the location services 124 may include providing directions to an address, providing geo-info look up from an address book, and providing suggested travel routes and modes of transportation.

The location services 124 may be based on one or more GPS locations and a localized map. Alternatively or in addition, the location services 124 may incorporate geo-fencing or boundary containment as is known in the art. A defined zone with a predetermined speed limit, one-way street information, and/or a boundary having a permit-use restriction may be applied. In one embodiment, the location services 124 work in conjunction with the location-based services offered from a CellAntenaTower triangulation method. One or more identification modules 120 may facilitate locating the user and/or a desired location or boundary in certain embodiments.

The information services 126 may include providing general information, similar to a concierge services in one embodiment. The information services 126 may provide information about local attractions and the availability of transportation services, shops, restaurants, and the like. In certain embodiments, the location services 124 and information services 126 may be coordinated to provide specific information to the user. For example, the mobility services 122 may provide the location of a parking space or the wait time for a racquetball court or opening at the spa. In one embodiment, the information services 126 may provide information specific to a community or campus such as a housing development, gated community, resort, school, or the like. In certain embodiments, the mobility services 122 may be used to make reservations and the like. Using automatic identification, such as through the identification module 120, the mobility coordination system 100 may facilitate accessing user-subscribed premium services such as CNN business news, XM satellite radio services, and the like.

In addition to the information services 126, the mobility services 122 may include a communications service 128 to enable the user to communicate with other resources. In one embodiment, the communication service 128 provides VoIP (voice over internet protocol) services, instant messenger text, video chat, and the like to connect the user with others. The communications service 128 may facilitate receiving answers to inquiries and making decisions while traveling or commuting. In certain embodiments, the communication services 128 are enabled through independent service providers.

Entertainment services 130 may be available to enhance the “down time” that often occurs during traveling. In one embodiment, entertainment services 130 include internet radio, mp3 downloads, internet television, movies, online shopping and the like.

Emergency services 132 may include a connection to security or to the local emergency services. In certain embodiments, the emergency services 132 automatically connect the user to an emergency response unit in the event of an accident or the like. In a further embodiment, the emergency services 122 may include a translator or the like to translate key phrases into a foreign language. A translator or translated phrases may be beneficial in an emergency situation, particularly if the user is in an unfamiliar territory.

Customized services 134 may range from participation in a special-interest group to health care services. Customized services 134 may further include changes in a customer account, subscription, or user preferences. In one embodiment, the user may receive additional mobility services 122 at any time; however, the customer account may be charged an additional fee for the upgrade or for use of the services 122. In certain embodiments, the mobility services 122 may be configured to comply with ISO (International Organization for Standardization) section 508 to assist those with disabilities. In one embodiment, the customized services 134 provide travel planning and arrangements customized to the user's needs and/or user preferences.

Transportation services 136 may also vary depending on the needs of the user. In one embodiment, the transportation services 136 include a number of pre-paid travel miles the user may use on any associated transportation device. The miles may include rentals such as a car rental, bike rental, Segway™ rental, or the like. In addition, the miles may include public transportation systems, taxis, trains, buses and the like. Transportation services 136 may further include ride assistance, scheduling, and onward connections.

In one embodiment, the location services 124 and the transportation services 136 are coordinated to facilitate providing transportation for the user. The user may authorize the system 100 to communicate his/her location to a number of transportation services. Similarly, the system 100 may provide the location of transportation services or devices available to the user. For example, if the user commutes through a carpool or a shuttle service, the participants in the carpool may be able to locate each other through the mobility coordination system 100. If one participant is extremely late or misses an indicated shuttle, the mobility coordination system 100 may help the participant locate another shuttle or carpool that is able to take to the participant to his/her destination. In one embodiment, the mobility services 122 may communicate a message to multiple users.

In certain embodiments, the mobility coordination system 100 may include financial services 138 to enable the user to pay a single bill for mobility services 122. Alternatively, the financial service 138 may debit a user's financial account for transportation services or the like. For example, on the way to work, a user may park a car at a parking facility, catch a train to one part of the city, and take a taxi from the train station to his/her work location. Typically, the user may make a financial transaction at each location, which may be time consuming and could potentially cause the user to arrive late to work. In one embodiment, the mobility coordination system 100 automatically debits the required fee amount from the user's checking account, credit card account, or the like. Alternatively, the cost of a certain number of travel miles may be included in the subscription fee, regardless of the mode of transportation. Thus the mobility coordination system 100 may provide a pass for the user to use the transportation device or service without making a separate financial transaction.

In certain embodiments, an identification module 120 may be associated with a mobile access device 116, identification card, or the like that travels with the user. Alternatively or in addition, one or more identification modules 120 may be located in an access device 116 or the like at a train station, rental station, taxi service or the like. As a result, the user may pass through a gate, boundary, or the like that recognizes the user's identification module 120 and communicates the event to the mobility coordination system 100. Consequently, the mobility coordination system 100 may track the miles and/or usage associated with the customer account and/or identification module 120.

A brick and mortar transportation store may be available to set up a customer account and to advertise available mobility services 122. In certain embodiments, a live attendant may be available to answer questions and to explain services, payment plans, available transportation devices, and the like. In one embodiment, the transportation store offers discounts and/or passes for public transportation, vehicle rentals, etc. In an alternative embodiment, the mobility services 122 may be available for purchase through the internet 114 or by phone. A call center may be available to provide technical support and/or customer services. Customer service may be provided through multimedia enabled assistance such as video, text, voice, TextToSpeech (TTS), InteractiveVoiceResponse (IVR), and the like.

In one embodiment, the mobility services 122 are available through three different levels of service plans. A high end luxury group plan may be available to multiple users and may provide all of the mobility services 122 as well as unlimited prepaid travel miles. A mid-level value plan may provide a selected number of mobility services 122 and a limited number of prepaid travel miles. A basic level plan may provide a basic number of mobility services 122 with fewer prepaid travel miles.

In a contemplated embodiment, the network 102 may be available within a pre-planned community to provide coordinated personal mobility services 122 to the residents. Each residential dwelling place may be built to include a personal vehicle, which may be included in the selling price of the dwelling place. The personal vehicle may include a dashboard computer that is GPS enabled and may further include a mechanism to connect to WiFi/WiMax networks.

In certain embodiments, the location service 124 provides individual visibility to other members of a group or community. For example, the residents of the pre-planned community may be able to selectively make their vehicle visible to others in the community. As a result, if John is playing golf, his friend Jerry may be able to view his location through the network 102 and join him if desired. In addition, visibility may be made available through other access devices 116. In certain embodiments, the identification module 120 facilitates enabling visibility.

In one embodiment, the customer account includes customer-defined preferences that enable the user to identify various groups of people that may be connected through the visibility feature. For example, the user may determine a carpool group, a family group, a work group, a friends group, etc. Subsequently, the user may select to which group he/she would like to be visible. A stealth mode may be available to prevent the mobility coordination system 100 from informing an individual and/or group of people of the user's location.

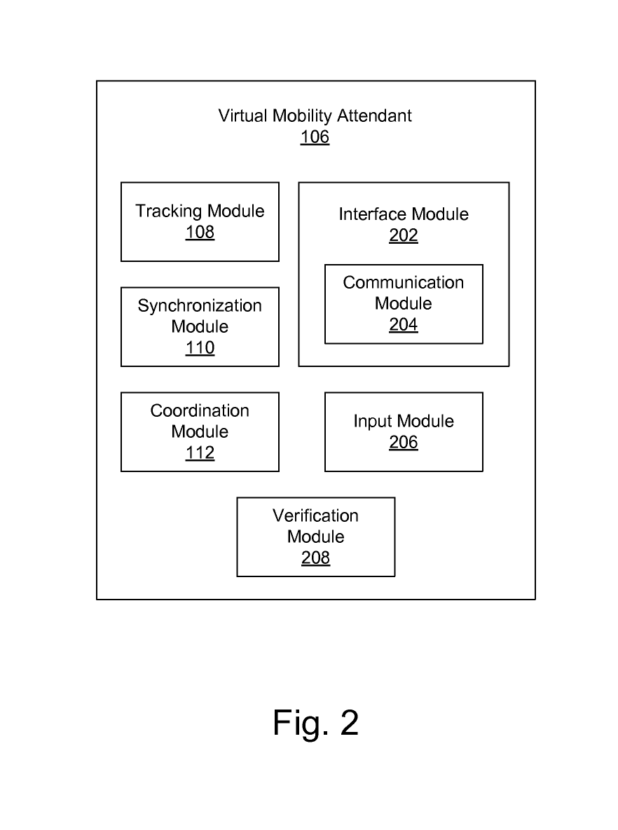

FIG. 2 illustrates one embodiment of the virtual mobility attendant (VMA) 106 in accordance with the present invention. In the depicted embodiment, the VMA 106 includes a tracking module 108, a synchronization module 110, a coordination module 112, an interface module 202, a communication module 204, an input module 206, and a verification module 208. The VMA 106 may provide an interface for the user to facilitate coordinating mobility services 122.

The tracking module 108 may facilitate tracking the location of the user, another user, and/or a transportation device. Tracking the location of the user and/or a transportation device may facilitate coordinating mobility services 122. For example, if the user is located in a certain part of town, the tracking module 108 may receive input about the location of a transportation device, such as a bus or taxi, for example, in close proximity to the user. Subsequently, the VMA 106 may inform the user of the location of the transportation device, and may additionally inform the driver of the transportation device of the whereabouts of the user in certain embodiments. Thus the user may easily be provided with transportation.

In another embodiment, the tracking module 108 may facilitate tracking other people identified as a member of a group. For example, the tracking module 108 may provide tracking information about a family member, co-worker, or a resident of a community as described above. In certain embodiments, the tracking module 108 receives input from a GPS enabled device, an identification module 120, a geo-fencing system, and/or the like. In one embodiment, the user provides the location information to the VMA 106.

In certain embodiments, the tracking module 108 tracks the user and/or a transportation device relative to a map. The map may be of a building, transportation system or designated route, a part of a city, or the like. The tracking module 108 may receive information from a database to provide a current map for the location of the user or the like. In certain embodiments, the tracking module 108 enables the location services 124.

The synchronization module 110 synchronizes user input and at least one mobility service 122. In one embodiment, the synchronization module 110 receives input from a calendar program or the like and synchronizes the user's schedule, addresses, and “to do” list with the current time and location of the user. Thus the VMA 106 may monitor whether the user is located near a scheduled event. If the user is not at a scheduled location at the appropriate time, the VMA 106 may communicate a message or reminder to the user. Alternatively or in addition, the VMA 106 may provide instructions to arrive at the location of the scheduled appointment. In a further embodiment, the VMA 106 may arrange transportation to arrive at the appointment.

The coordination module 112 coordinates user data and collective data to provide at least one mobility service 122 customized to the user. For example, the coordination module 112 may coordination the location of the user and a desired destination with the route of a local transportation system to enable the user to arrive at the destination. Collective data may refer to any information that is generally provided by someone or something other than the user. For example, the location of other individuals and/or a transportation vehicle may represent collective data. Furthermore, collective data may refer to information provided by a transportation system or other source of information. In certain embodiments, the collective data may be dynamic and may be updated in real-time; for example, departure/arrival times and traffic information.

The coordination module 112 may coordinate the user data with the collective data to make arrangements for travel. For example, the coordination module 112 may access a user's customer account and arrange for tickets to travel at a designated time to a desired destination by a preferred mode of transportation.

In a further embodiment, the coordination module 112 may reference the user preferences and evaluate received collective data to determine a recommended route and mode of travel for the user. The user data may include information received from the tracking module 108 and the synchronization module 110 in certain embodiments.

The interface module 202 may provide the interface between the user and the VMA 106. In certain embodiments, the interface is viewable through a display device. Alternatively, the interface may comprise an audible message or the like. In one embodiment, the mobility services 122 are selectable through a menu of options. In certain embodiments, the interface includes an animation or icon that communications with the user.

In select embodiments, the interface module 202 further includes a communication module 204. The communication module 204 may trigger one or more mechanisms to communicate with the user. For example, if the VMA 106 determines that the user has an appointment that may be missed, the communication module 204 may attempt to notify the user by phone, text message, email, a pop-up message on a computer, an alarm, or the like. In certain embodiments, the user may be required to acknowledge the message within a certain amount of time. The method of communication may be selectable through the user preferences in certain embodiments.

In one embodiment, the communication module 204 simultaneously initiates communication with a plurality of access devices 116 associated with the user. For example, the VMA 106 may send a message to a laptop, a cell phone, and a PDA to ensure that the user receives the message. Once the user responds to one form of communication, attempts to communicate through other access devices 116 may be terminated.

The input module 206 may facilitate establishing a customer account and may store information relative to the user. The user may be able to change and/or update stored information. In one embodiment, the input module 206 receives one or more user preferences that enable the VMA 106 to function according to the preferences. The input module may further include stored information relative to a user's financial account or the like.

In certain embodiments, the input module 206 may further be configured to receive information relative to other users or mobility services 122. For example, the input module 206 may receive the location of a family member listed in the preferences. In addition, the input module 206 may receive information updates from other sources, such as an updated arrival/departure schedule. In yet another embodiment, the input module 206 receives information relative to the usage of the account. For example, if the user travels a number of pre-paid miles, the input module 206 may update the information in the account. Furthermore, if the user fails to maintain a desirable account balance, the VMA 106 may provide limited services or may be disabled completely.

In one embodiment, the VMA 106 may be configured according to user-selected parameters, such as parameters for work or leisure activities, for example. In addition, the VMA 106 may prioritize mobility choices according to a determined cost-effectiveness such that the most cost-effective choice may be listed or presented first. Alternatively or in addition, the VMA 105 may prioritize choices according to an estimated time of arrival or the like. Thus, the user may select the order and type of mobility choices the VMA 106 presents. In certain embodiments, the VMA 106 creates periodic reports, such as weekly or monthly, to enable the user to re-evaluate the set parameters and to make changes to refine the performance of the VMA 106.

The verification module 208 verifies the identity of the user for security and account maintenance. In certain embodiments, the verification module 208 receives input from the identification module 120 to associate a mobility service 122 with the user's customer account. In another embodiment, the verification module 208 references an existing form of identification, such as a cellular phone account or an access device 116, to verify the user. In an alternative embodiment, the verification module 208 may verify a user login to access the user's customer account.

The VMA 106 may provide many different mobility services 122 for various levels of customer membership. In certain embodiments, the VMA 106 is configured to learn from patterns of the user or from the user's requests. The VMA 106 may also be configured to make suggestions, to provide reminders, and to guide the user.

In certain embodiments, the VMA 106 is configured for international use or for user access from around the world. In one embodiment, the VMA 106 prompts the user to identify where the user would like to go, and the VMA 106 determines a preferred travel route and method. The travel route may be synchronized to the user's time schedule and may be responsive to the user's preferences. In one embodiment, the VMA 106 further provides information about points of interests.

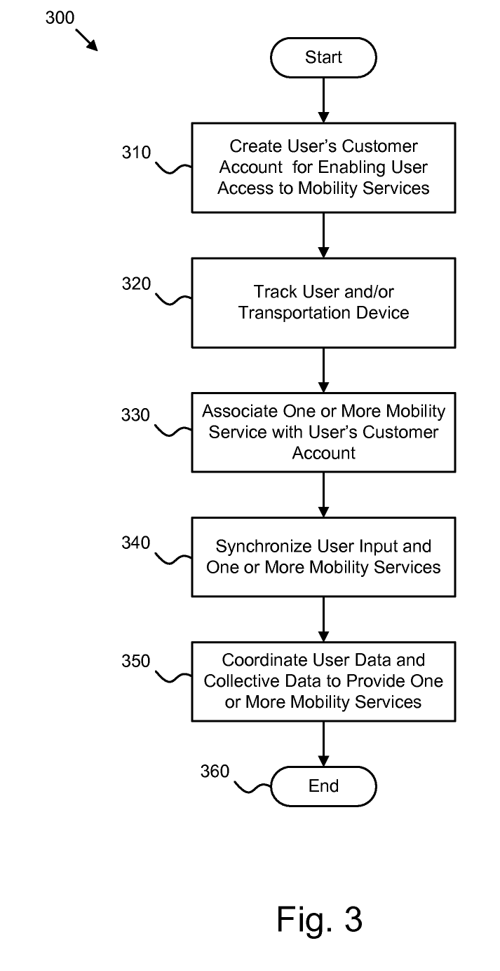

FIG. 3 illustrates one embodiment of a mobility coordination method 300 in accordance with the present invention. The mobility coordination method 300, in one embodiment, includes creating 310 a user's customer account for enabling user access to the mobility services 122, tracking 320 the user and/or a transportation device, associating 330 one or more mobility services 122 with the user's customer account, synchronizing 340 user input with one or more mobility services 122, and coordinating 350 user data and collective data to provide one or more customized mobility services 122.

In one embodiment, a user's customer account is created 310 to allow the user to access mobility services 122. The user may provide personal information as well as user preferences. In one embodiment, the user receives access to the mobility services 122 through the VMA 106. The life of the VMA 106 may be associated with the amount of money paid for services. Failing to provide payment may terminate access to the mobility services 122. In certain embodiment, an access device 116, such as a kiosk terminal, a desktop computer, a web terminal, a PDA, a cellular phone, a call center attendant, Interactive Voice Response (IVR), Voice/Speech recognition system and/or the like, enables the user to access his/her customer account and to receive coordinated mobility services 122.

The VMA 106 may facilitate tracking 320 the user and/or a transportation device. In certain embodiments, the access device 116 may receive location information from a GPS-enabled device. The location information may be communicated to the VMA 106 to facilitate providing mobility services 122. In addition, the VMA 106 may access satellite photographs, maps, and the like to provide visual tracking for the user.

In certain embodiments, tracking 320 the user and/or a transportation device facilitates associating 330 one or more mobility services 122 with the user's customer account. One or more identification modules 120 may facilitate associating one or more mobility services 122 with the user's customer account. In one embodiment, a kiosk terminal is equipped with WiFi, a card reader, RFID, and/or Bluetooth. An identification card or the like carried by the user may interact with the kiosk terminal to login the user and/or to associate a mobility service 122 with the user's customer account. In another embodiment, a call center may provide a human to human to machine interface. An operator in the call center may be able to provide mobility services 122 to the user through verification and/or identification of the user's customer account.

In a further embodiment, the coordination method 300 includes synchronizing 340 user input with one or more mobility services 122. User input may be downloaded, copied, or maintained though the network 102 to enable the VMA 106 to synchronize the user input with one or more mobility services 122 to facilitate determining transportation decisions. In one embodiment, user input includes personal information, such as an address book, a calendar, a “to do” list, one or more group lists, and the like.

The mobility coordination method 300 may further include coordinating 350 user data and collective data to provide one or more mobility services 122 customized to the user. User data, such as a desired time of arrival, a destination, and the user location, may be coordinated with collective data, such as a traffic report, for example, to provide a customized travel itinerary to arrive at the desired destination.

The mobility coordination method 300 subsequently ends 360.

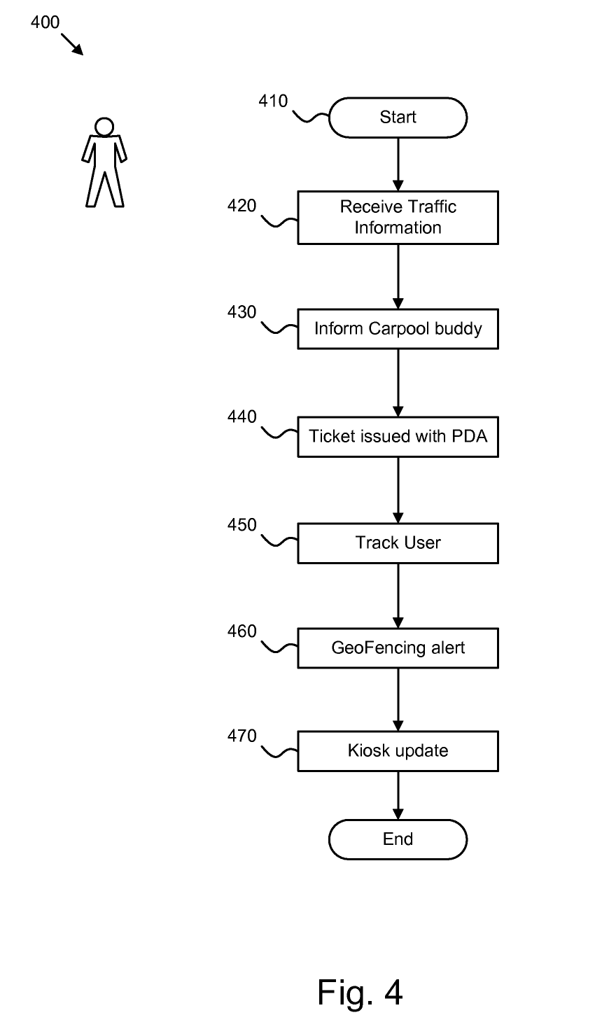

FIG. 4 illustrates one embodiment of a method 400 for coordinating mobility service in accordance with the present invention. In one embodiment, the method 400 is provided through the VMA 106. The mobility service 400 coordinates user data and/or user input to determine a destination and a time of arrival. The method 400 begins 410, in one embodiment, by receiving traffic information 420 and subsequently coordinating the current location of the user together with the desired destination and the traffic information. As such, a destination time may be determined and an optimal route determined. Receiving 420 information may, in one embodiment, comprise accessing a RSS (Really Simple Syndication) feed summarizing traffic news.

In the event that the VMA 106 determines that traffic may cause a delay, the VMA 106 notifies the user of the traffic delay and suggests a leaving time. The method 400 continues and the VMA 106 notifies 430 carpool buddies (if any) of the possible delay and the subsequent change of departure time (in order to compensate for the delay). In one embodiment, notifying 430 may comprise the VMA 106 sending a short message service (SMS) message to each carpool buddy, or alternatively an email. The message may comprise location information of the user in order to calculate departure and arrival times. Alternatively, the message may include the new estimated arrival time.

In one embodiment, the VMA 106 tracks the user until the user reaches the carpool on time. In preparation, the VMA 106 may issue 440 a train ticket to allow the user to board the train on time. The VMA 106 may continue to track 450 the user and coordinate the user's location with the available transportation. For example, if the VMA 106 determines that travel by bus will result in an earlier arrival time than travel by train due to traffic conditions, the VMA 106 will instruct identify the specific bus to board and provide the user with a boarding pass. The VMA 106 may be further configured to transfer funds to the transportation company, in this example the bus, in order to pay for the boarding pass.

A geofencing alert 460 provided by the VMA 106 indicates to the user that the bus is arriving at the bus stop, for example. A kiosk update 470 enables the VMA 106 to provide a personalized suggestion to pick up coffee. A geo-fencing alert 470 enables the VMA 106 to forewarn the user of the shuttle's arrival. Subsequently, the user is able to arrive 480 at work on schedule.

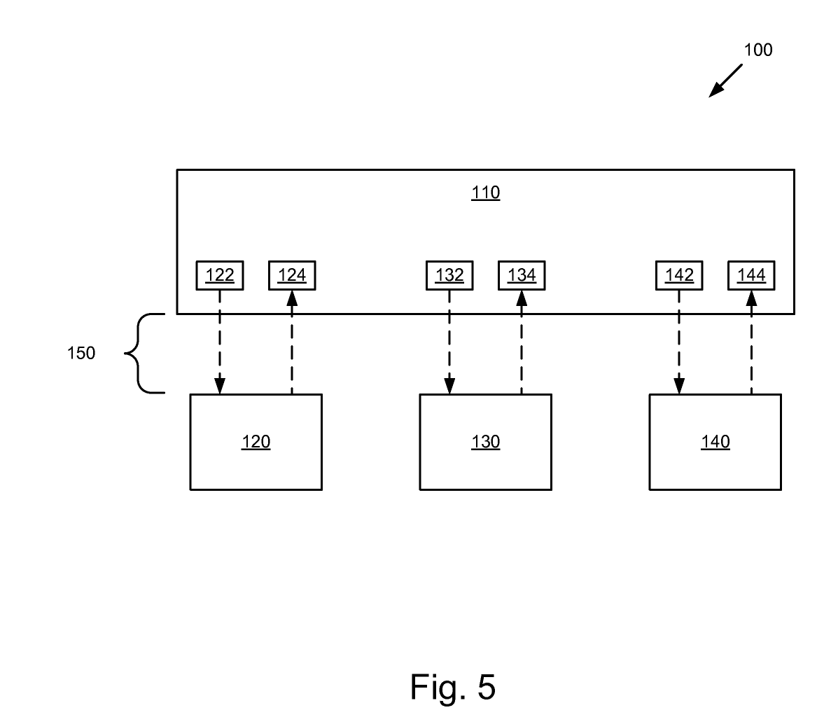

FIG. 5 is a schematic block diagram illustrating one embodiment of an overall infrastructure for a personal vehicle management system in accordance with the present invention. The vehicle management system 500 operates in conjunction with transit system 510. In one embodiment, the transit management system 510 is the server 104 described above with reference to FIG. 1. Transit system 510 will typically include one or more fleets 520 from numerous franchisees, and thereby be independent of each other. The fleets can be of different types of groups, such as corporate fleets, service fleets, city fleets, homeowner associations, rental fleets, shared fleet, and individual owners as described in further detail below. One or more data objects 522, 524 representing individual vehicle position, or location information, are transferred between transit system 510 and fleet 520.

Transit system 510 receives real-time or otherwise current supply information from a number of personal vehicles in one or more fleets 520 of vehicles. Supply information may include, without limitation, location information, vehicle options, the number of passengers in a vehicle, and/or the vehicle occupancy limit. The location information is typically in the form of global positioning system (GPS) data, as acquired by analog or digital location units installed in the personal vehicles. Thus, in an exemplary embodiment, location information of the personal vehicles in fleet 520 is transferred to transit system 510 from GPS-enabled devices located on the personal vehicles. In this way, supply information from one or more personal vehicles is received by transit system 510.

Vehicle management system 500 also includes one or more end user presentation and interface generation systems 530 delivering information, represented in FIG. 5 by data objects 532, 534, to transit system 510 regarding their location and user preferences for a personal vehicle having one or more end user-defined, or desired, features in the one or more fleets 520. Following receipt of this user-defined “demand information,” a target vehicle or group of target vehicles is identified which most closely matches the vicinity and features in the user-defined demand information. Thus, the target information regarding the chosen vehicles is determined from the supply information and the demand information for the personal vehicles in a vicinity most closely matching the end user demand information, and this target information is transmitted to the end user for end user vehicle selection. In this way, transit system 510 receives a user's request via the presentation system 530, queries transit system 510 to determine a set of vehicles that satisfy user-defined demand parameters of the request, and transmits data describing the result set to the end user's device for display. The end user requests can be delivered to transit system 510 via electronic devices such as cell phones, PDA's, computers and the like.

An accounting system 540 may be employed in the determination of target information of the vehicles most closely matching the user-defined preferences. Accounting system 540 transfers data 542, 544 to and from transit system 510 for use in determining the target information and faciliatating the completion of the end user's vehicle selection. In an exemplary embodiment, the accounting system 540 employs one or more dynamically variable accounting methods such as plan subscriptions, coupons, earned bonuses, transfers and subsidies, such that transit system 510 determines, or matches, the desirable vehicle to the end user. In one embodiment of the invention, in order to facilitate the completion of the user's purchase request, a telematics system, as described below, is in communication with credit services, pre-paid cards, campus identification cards, or any other system that may be needed and that is configured to facilitate a consumer purchase available via the internet or by other transmission means.

Vehicle management system 500 includes communication conduit 550 coupled to fleet 520, end user 530, and/or accounting system 540, for receiving and/or delivering supply, demand, accounting and/or target information related to the vehicles within the fleet(s). The communication conduit 550 is preferably a high bandwidth communication system, and may include one or more of the following: satellite data link, cellular telephone communications link, radio link, bluetooth, 802.11, a wired communications link, or any other suitable wireless communications datalink. The communications conduit 550 used in a particular system may be dependent upon the nature of the vehicles and/or end user preferences. Communication conduit 550 is preferably capable of transmitting one or more of the following: audio (panic E911, customer assistance, telephony communications); video (300 KBps each way for full duplex communications); vehicle active reporting (1 KB packet, 10 times per second; vehicle idle reporting (½KB packet, once per second); and/or secure packets for user authentication and electronic transactions.

In one embodiment, one or more vehicles utilizes communication conduit 550 to provide a mapping service based on GPS and local maps such that real-time display of position information can be relayed between and/or among the one or more vehicles and the transit system 510 through communication conduit 550. Such information flow of positioning information affords each vehicle and transit information system manager 510 to know the location of the other vehicles in the fleet, available parking information and, optionally, available travel routes. Communication conduit 550 also preferably allows for the dynamic display of vehicles and/or the ability to talk to occupants in selected vehicles.

A variety of means may be utilized to by communication conduit 550 to visually convey information from transit information system 510 to an end user. In one exemplary embodiment, the system is capable of allowing an occupant of one or more vehicles to receive video to a video system located on the vehicle or other personalized services and/or to purchase media content. To facilitate this capability, the user sends a request to purchase the selected content to the telematics system. The telematics system may be any one of numerous types of systems that operate remotely (external to the vehicle) and that may provide various remote services to the user. An exemplary telematics system includes an OnStar satellite system, as described above, available from OnStar Corp. of Troy, Mich. The OnStar product provides concierge services, vehicle assistance services, remote vehicle unlocking/locking features, navigational services, and vehicle tracking services.

The video system may be provided with the ability to offer a variety of functionalities. These functionalities may be hardwired or programmed within the video system or the functionalities may be added in a modular manner via an expansion slot provided within the video system. Contemplated functionalities include, but are not limited to satellite television (for example, DirectTV), satellite radio (for example, Sirius, XM), Pictel phone, GPS guidance systems, memory cards, wireless internet access such as Wi-Fi, Bluetooth, digital video recorders, video conferencing, cellular digital, USB capabilities, Blue sphere, Blu-ray technology, satellite video import cards, wireless download capabilities, etc.

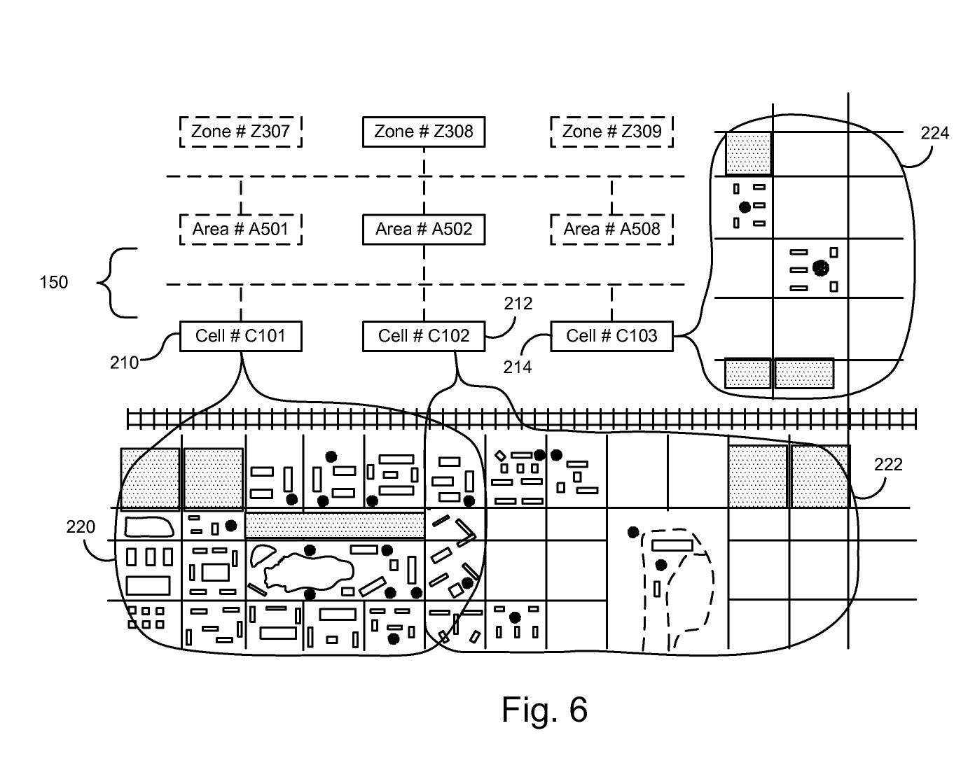

As illustrated in FIG. 6, the fleets can operate in the same, overlapping or different geographic franchise, or “cell zone” areas 610, 612, 614. FIG. 6 shows cell zones 610 and 612 having overlapping geographic areas 620, 622; cell zone 614 is separate and is associated with geographic area 624, and does not overlap cell zones 610 or 612. In some embodiments of the invention, a transit information management system may be operated by a dispatch agency and contain information for the vehicles of one or more service companies. In this way, the vehicle management system 500 operates to aggregate the information from a number of disparate and unrelated sources, thereby providing end users with a much larger and richer source of information and vehicle selection options than would otherwise be available to the end user by directly contacting any one of the underlying business operating the personal vehicle fleet. Cell zones 610, 612, 614 are capable of communicating dynamically and in real-time with each other and with the transit system (not shown) through communication conduit 550 such that a fluid and flexible franchise arrangement is achieved.

For example, vehicles within franchise models 610, 612 are capable of communicating with each other and franchise 614 such that if a particular vehicle in model 610 exceeds the given geographic scope of franchise model 610, and enters the geographic scope of model 612, it then becomes a member of franchise model 612. When such a transfer occurs, information regarding the particular vehicle is communicated among franchise models 610 and 612 and to franchise 614 in a dynamic and real-time manner. This information is also transmitted to the transit system such that end users are given the option of choosing the transferred vehicle when the transit system is queried as described in further detail herein.

In one embodiment, a small franchise of approximately 25 personal vehicles having a geographic scope of 2 square miles is provided. In another embodiment, a medium franchise is provided having about 100 personal vehicles bounded geographically to 8 square miles. In yet another embodiment, a large franchise of about 500 personal vehicles having a geographic scope of 20 square miles is provided. Exemplary service models include basic, premium, extravaganza, as further described below. Such a franchise arrangement affords fluid, dynamic and real-time modifications that form one aspect of the present invention.

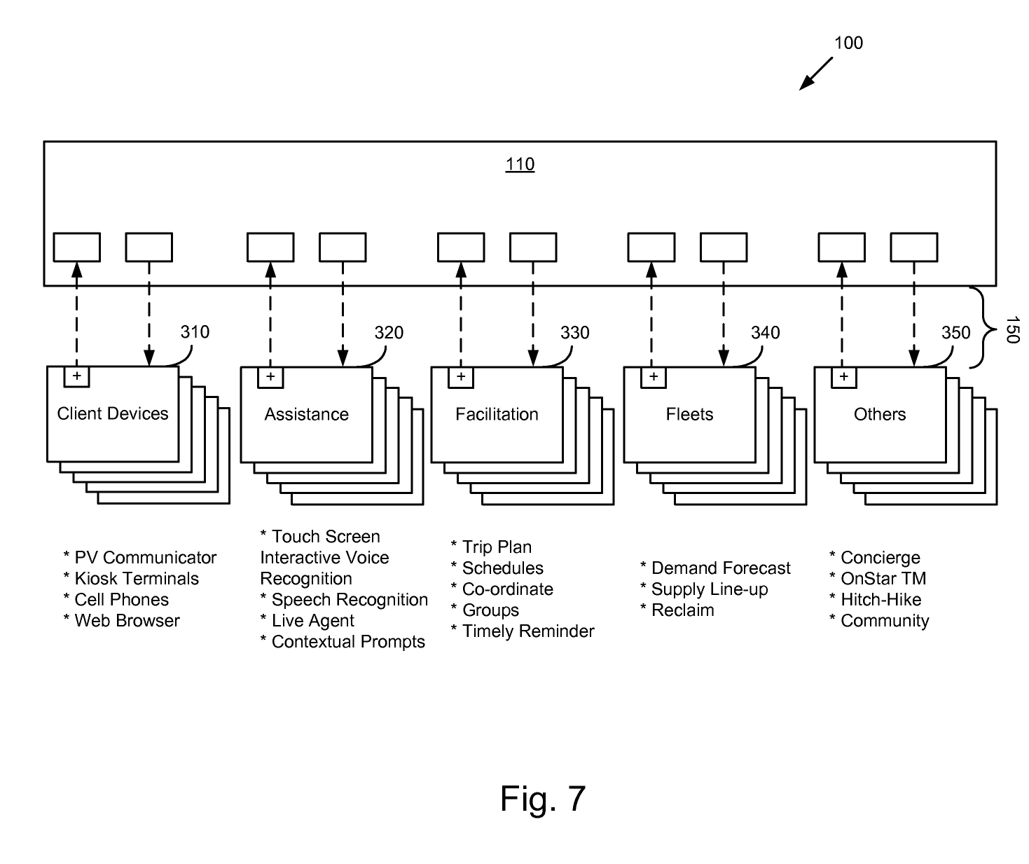

FIG. 7 is a schematic block diagram illustrating another embodiment of the system 500 in accordance with the present invention. The depicted embodiment illustrates a system 500 capable of receiving and delivering supply, demand and accounting information as described above, through communication conduit 550 with a variety of devices such as client devices 710, assistance devices 720, facilitation devices 730, additional fleets 740, or other third party devices to provide end-user customized mobility assistance, such as the virtual mobility attendant described above. In one embodiment of the invention, a transit system manager computer application is run on transit system manager 510. Transit system 510 is coupled to a repository for analyzing the status information as a function of the historical and vehicle specification information. An end user or users may access the system 510 to download or review the status information for any, all or a subset of vehicles within a single fleet or between multiple fleets.

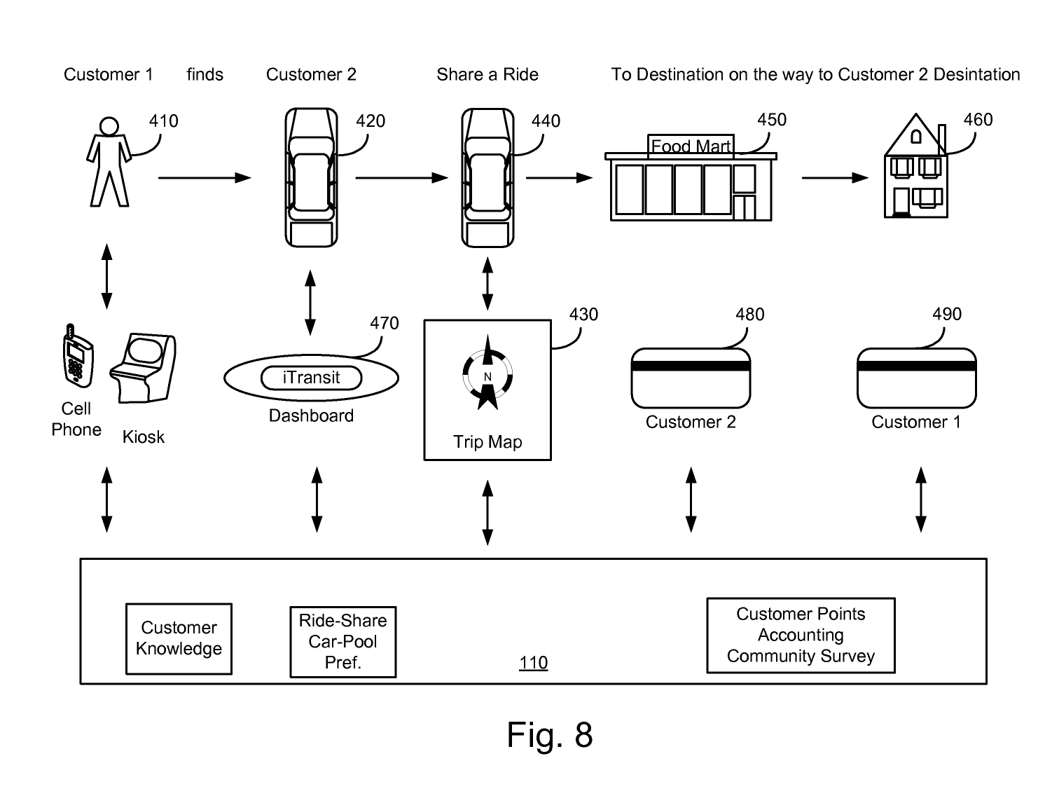

FIG. 8 is a schematic block diagram illustrating one embodiment of a method for utilizing the vehicle management system 500 in accordance with the present invention. The first end user 810 queries the transit system 510 for a personal vehicle capable of delivering the first end user 810 to a desired location, and if possible, most closely matching or satisfying certain personal parameters of the request. The transit system 510 identifies a set of vehicles and delivers the available set of vehicles to the end user 810 via an end user device 815, allowing the end user 810 to select a desired vehicle.

There are a variety of methods for limiting the vehicles delivered to first end user 810. The transit system could limit vehicles retrieved to those that would appear in the viewing area of a map 830 chosen by the user(s) or transit system 510. Another method would be to give end users a “community rating” and only display vehicles where the first end user request and the desirable community rating of the second end user overlap. For example, a user searching for vehicles driven by, or including occupants, having a poor community rating would be filtered out and not presented to first end user 810 by transit system 510.

The result set can be further constrained or filtered to include only vehicles of certain types or desired characteristics. In the same way, second end user 820 inputs desired or allowable ride share end users that second end user 820 deems acceptable using any of the filtering methods described above. Transit system 510 then matches acceptable ride share options with selected end users. When a desirable matching second end user 820 is selected by first end user 810, second end user 820 is notified via an end user device such as dashboard 870, picks up first end user 810, illustrated in FIG. 8 as object 840, and drops the first end user off at his predetermined destination 850. Following drop-off, second end user 820 continues on to second end user's destination 860. In this way, the first end user 810 and second end user 820 are able to efficiently utilize a single vehicle to share the cost of a ride, or “ride share.” Transit system 510 then performs the required accounting such that second end user's account 880 and first end user's account 890 are charged less than would be charged if they had each used separate personal vehicles.

The accounting method described above can be achieved by a number of methods. A method of simply deducting money from an end user's account in accordance with the parameters selected by the end user may be employed. Such a method may include deducting money from the end user's account dependant on the type of vehicle selected, the kind or number of options selected or utilized during a ride, length of the trip or time of use, whether a ride-share was included, as discussed above, etc.

Alternatively, the accounting method includes, according to one aspect of the invention, a dynamically variable accounting method of creating credit transactions for internal virtual-world calculations within transit system 510 and determining real-world equivalence, such that an end user can use “transit points” for commercial tender. Such a method includes providing a virtual-world charge account service to the end user and accepting transactions charged to the virtual credit account in connection with purchase activities in the virtual-world or real-world, and providing a statement in electronic or paper form to the end user who acquires the virtual credit account. In this method, the virtual credit account is valuated in non-monetary virtual-world transit points for use on one or more of the personal vehicles.

An end user can purchase the transit points with monetary real-world money directly through a terminal, online, at an automatic teller machine (ATM) or by using any of the end user devices described herein, such as kiosks, PV communicators, web browsers, cell phones, etc. Alternatively the transit points can be purchased by others or traded with others. The transit points are preferably exchangeable with commercial airline mileage points, cyber money, and product purchasing points. In an exemplary embodiment, transit points are purchased in the form of U-ride miles™ having a monetary equivalence of approximately 0.10 U.S. Dollars, for example.

With regard to the features of the vehicles in the fleet(s), one or more vehicle may include one or more sensors (not shown) for measuring vehicle parameters such as battery charge level, safety, obstruction detection, etc. Preferably, every vehicle in the fleet includes at least one sensor. In one embodiment, each vehicle includes a microprocessor based controller or “personal vehicle communicator” (PV communicator), for receiving signals from the one or more sensors, storing the data, and/or calculating other vehicle parameters based on the sensor data.

The PV communicator may include the dynamic display of personal vehicles in real time with charge levels and/or occupant view, available personal vehicles on parking docks, the ability to talk to specific personal vehicles, and call forwarding to cell phones with screen display. One aspect of the invention includes a basic service model that includes one or more of the following features. An end user authentication unit authenticates the end user to an ignition system when the end user attempts to start the vehicle. The end user authentication unit authenticates the end user using ID card reading means and/or via a biometrics authentication. When the biometrics authentication is used, a physical feature such as the fingerprint or iris of the user who is to be permitted to drive the vehicle is registered in advance at the user authentication unit, optionally together with additional information.

A disable command can be utilized to immediately and remotely disable and, thus, safely demobilize a specified vehicle. For example, the disable command can be used to interrupt fuel flow to the engine or disable the ignition. The system may further have the ability to monitor the power level of each of a plurality of vehicles within or near the transit information system 510. Each vehicle may have a battery charge of a particular time period. Each vehicle may monitor its own power levels and may communicate the power levels periodically, or upon request, to franchisees and/or transit information managers. Alternatively, the system may be configured such that when the vehicle power drops to a predetermined level, an alert may be generated and sent to the transit information manager. The power levels may further be provided to the user such that, should the power level be low, the user becomes aware of the drivable range, and may return the vehicle or trade for another vehicle. Further, upon receipt of notification that a vehicle is low on power, the transit information system may remove the vehicle from use and recharge it or replace the battery.

Enhanced wireless 911 (E911) emergency services may be available to provide vital information necessary to locate and identify a driver in an emergency and/or provide attendant help. One embodiment of the invention includes geo fencing. Geo fencing allows the transit system to define specific areas that can be determined as “off limits” based on the end user profile or other parameters, and as such may trigger an alarm if the given vehicle exits the defined space. Alternatively, a speed limit may be imposed if a vehicle enters predetermined, geographic regions. A navigation system may be included on one or more of the vehicles to provide routing information, driving instructions and mapping services to an end user. Remote drive using camera vision and park-n-go docks are also contemplated by the present invention.

Another aspect of the invention includes a premium service model that includes one or more of the following features. Advanced functionality of the vehicle, such as high bandwidth communications; onboard cameras; and sensors for safety, obstruction detection, etc. Value-add services, such as concierge services; OnStar services; video services; and personalized services may also be included. Services on the dashboard include a mapping service such as GPS, and local mappings. Optionally, “you are here,” displayed in realtime, along with the route needed to travel to get the user to his or her destination and/or to locate additional vehicles in the fleet is included.

Additional components contemplated by the present invention which maybe included on any, all or a subset of vehicles within the fleet, include a variety of value-add services. For example, concierge-type services whereby a restaurant, address, or other type of listing can be provided. In addition, a telematic system and service center may be included within or more fleets. Such a telematic system and service center may be substantially similar to known systems and centers, such as General Motors' OnStar, Daimler's TELEAID, Ford's RESCU or the like, which are common in vehicles. Such telematic systems involve a telecommunication link from the vehicle to an operator or a voice input system at a service center or the like external to the vehicle. The control of the vehicle may connect or communicate with an operator at the service center to request directions to a targeted location or to request roadside assistance or other services, such as concierge service and the like.

One aspect of the present invention includes a vehicle management system and method for managing a plurality of vehicles configured to operate within the framework of the franchise arrangement described above. The present invention may be utilized with a number of different types of vehicles, including but not limited to, electric, gas-powered, and/or hybrid vehicles. Preferably the transit management system includes one or more personal vehicles. While the following description is provided with reference to the good or service being the provision or use of one or more personal vehicles, it is readily understood that the present invention contemplates and may extend to a wide variety of goods or services generally or traditionally provided within a franchise arrangement.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for coordinating customized mobility services through a network, the system comprising:
a network;
an access device configured to connect to the network;
a server configured to communicate with the access device through the network;
an identification module configured to identify a user's customer account and to associate at least one mobility service with the user's customer account; and
a virtual mobile attendant configured to coordinate customized mobility services through the network.

2. The system of claim 1, wherein the virtual mobile attendant further comprises a tracking module configured to track the location of at least one user and a transportation device.

3. The system of claim 1, wherein the virtual mobile attendant further comprises a synchronization module configured to synchronize user input and the at least one mobility service.

4. The system of claim 1, wherein the virtual mobile attendant further comprises a coordination module configured to coordinate user data and collective data to provide at least one mobility service customized to the user.

5. The system of claim 1, wherein the at least one mobility service is selected from the group consisting of location services, information services, communication services, transportation services, entertainment services, emergency services, and financial services.

6. The system of claim 1, wherein the server is further configured to maintain location information of at least one user and determine an optimal route for the user in response to traffic information.

7. A method for coordinating customized mobility services through a network, the method comprising:
connecting an access device with a network;
communicating with the access device through the network;
identifying a customer account and associating at least one mobility service with the user's customer account; and
coordinating customized mobility services through the network.

8. The method of claim 7, wherein the method further comprises tracking the location of at least one user and a transportation device.

9. The method of claim 7, wherein the method further comprises synchronizing user input and the at least one mobility service.

10. The method of claim 7, wherein the method further comprises coordinating user data and collective data in order to provide at least one mobility service customized to the user.

11. The method of claim 7, wherein the method further comprises maintaining location information of at least one user and determining an optimal route for the user in response to traffic information.

12. A method for dynamically managing transit information between personal vehicles and end users, the method comprising:
receiving personal vehicles supply information from at least one transit management system;
receiving demand information from a virtual mobility attendant;
determining target information from the supply information and the demand information for the personal vehicles in a vicinity most closely matching the end user demand information; and
transmitting the target information to the virtual mobility attendant.

13. The method of claim 12, further comprising transmitting location information of the personal vehicles to the transit management system from GPS-enabled devices located on the personal vehicles.

14. The method of claim 12, further comprising matching the end user with at least one dynamically variable accounting methods selected from the group consisting of plan subscriptions, coupons, earned bonuses, transfers and subsidies.

15. The method of claim 12, further comprising transferring end user vehicles between franchisee cell zones.

16. The method of claim 12, further comprising displaying the target information on a device selected from the group consisting of a cell phone, a web browser, a kiosk terminal, and a communicator.

17. A system for coordinating customized mobility services through a network, the system comprising:
a network coupling a transit management system and an access device having a virtual mobility attendant;
wherein the transit management system is configured to receive demand information from the virtual mobility attendant, determine target information from the demand information, and transmit the target information to the virtual mobility attendant; and
wherein the virtual mobility attendant comprises a tracking module configured to track the location of at least one user and a transportation device, a synchronization module configured to synchronize user input and the at least one mobility service, and a coordination module configured to coordinate user data and collective data to provide at least one mobility service customized to the user.

18. The system of claim 17, wherein the at least one mobility service is selected from the group consisting of location services, information services, communication services, transportation services, entertainment services, emergency services, and financial services

19. The system of claim 17, wherein the transit management system is further configured to maintain location information of at least one user and determine an optimal route for the user in response to traffic information.

20. The system of claim 17, wherein the transit management system is further configured to maintain location information of at least one user and determining an optimal route for the user in response to traffic information.
